(19) United States
(12) Patent Application Publication
(10) Pub. No.: US 2023/0186589 A1
(43) Pub. Date: Jun. 15, 2023

(54) METHOD AND SYSTEM FOR SENSING OCCLUSION

(71) Applicant: TOYOTA JIDOSHA KABUSHIKI KAISHA, Toyota-shi Aichi-ken (JP)

(72) Inventor: Tomoyasu TAMAOKI, Okazaki-shi (JP)

(73) Assignee: TOYOTA JIDOSHA KABUSHIKI KAISHA, Toyota-shi Aichi-ken (JP)

(21) Appl. No.: 18/070,611

(22) Filed: Nov. 29, 2022

(30) Foreign Application Priority Data
Dec. 10, 2021 (JP) 2021-201152

(51) Int. Cl. G06V 10/26; G06V 20/56

(52) U.S. Cl. CPC G06V 10/26; G06V 20/56

(57) ABSTRACT

The present disclosure relates to a technique for sensing occlusion by image recognition processing to an image acquired by a camera mounted on a vehicle. According to a method of the present disclosure, it is possible to reduce erroneously determining that poor visibility due to occlusion occurs although the occlusion does not actually occur. The method comprises sensing occlusion by image recognition processing to an image acquired by a camera mounted on a vehicle, sensing a blur-inducing motion, which is a motion of the vehicle inducing a blur in the image, and ceasing sensing the occlusion while the blur-inducing motion is sensed.

### CROSS-REFERENCE TO RELATED APPLICATION

The present application claims priority under 35 U.S.C. § 119 to Japanese Patent Application No. 2021-201152, filed Dec. 10, 2021, the contents of which application are incorporated herein by reference in their entirety.

### BACKGROUND

### Field

The present disclosure relates to a technique for sensing occlusion by image recognition processing to an image acquired by a camera mounted on a vehicle.

### Background Art

JP2019-535149A discloses a technique for detecting occlusion from an image acquired by a camera mounted on a vehicle and specifying cause of the occlusion based on surrounding environment. Darkness of a road, freezing of a windshield or a camera lens, or fogging of a windshield or a camera lens are exemplified as cause of occlusion.

### SUMMARY

A state referred to as occlusion or a shield, which is a state that a field of view is blocked and it becomes difficult to utilize an image, can occur to an image acquired by a camera mounted on a vehicle. If the image continues being used with poor visibility due to occlusion, there is a possibility that the vehicle is prevented from normally driving. Therefore, when the image cannot be utilized due to occlusion, it is necessary to deal with the state by, for example, deactivating the camera. In order to appropriately deal with the state, it is important to accurately determine the occurrence of poor visibility due to occlusion. However, there is also a state which is difficult to distinguish from occlusion, such as a state that the image is blurred. Therefore, there is a possibility that it is erroneously determined that poor visibility due to occlusion occurs although occlusion does not actually occur.

An object of the present disclosure is to provide a technique capable of reducing erroneously determining that poor visibility due to occlusion occurs when an image acquired by a camera mounted on a vehicle is recognized by image recognition processing.

The first aspect relates to a method comprising:

sensing occlusion by image recognition processing to an image acquired by a camera mounted on a vehicle;

sensing a blur-inducing motion, the blur-inducing motion being a motion of the vehicle inducing a blur in the image; and

ceasing sensing the occlusion while the blur-inducing motion is sensed.

The second aspect relates to a method comprising:

detecting an occlusion feature from an image acquired by a camera mounted on a vehicle;

sensing occlusion in response to the occlusion feature being detected continuously for a predetermined time or more

sensing a blur-inducing motion, the blur-inducing motion being a motion of the vehicle inducing a blur in the image; and

setting the predetermined time longer while the blur-inducing motion is sensed than while the blur-inducing motion is not sensed.

The third aspect relates to a system comprising:

at least one processor; and

a storage device storing at least one program,

wherein the at least one program is configured to cause the at least one processor to execute:
sensing occlusion state by image recognition processing to an image acquired by a camera mounted on a vehicle;
sensing a blur-inducing motion, the blur-inducing motion being a motion of the vehicle inducing a blur in the image; and
ceasing sensing the occlusion while the blur-inducing motion is sensed.

The fourth aspect relates to a system comprising:

at least one processor; and

a storage device storing at least one program,

wherein the at least one program is configured to cause the at least one processor to execute:

detecting an occlusion feature from an image acquired by a camera mounted on a vehicle;

sensing occlusion in response to the occlusion feature being detected continuously for a predetermined time or more

sensing a blur-inducing motion, the blur-inducing motion being a motion of the vehicle inducing a blur in the image; and

setting the predetermined time longer while the blur-inducing motion is sensed than while the blur-inducing motion is not sensed.

According to the present disclosure, it is possible to reduce erroneously determining that poor visibility due to occlusion occurs although the occlusion does not actually occur when an image acquired by a camera mounted on a vehicle is recognized by image recognition processing.

### BRIEF DESCRIPTION OF THE DRAWINGS

FIG. 1 is a schematic diagram for explaining an outline of a method according to an embodiment of the present disclosure.

FIG. 2 is a flowchart showing an example of processing in a method according to a comparative technique.

FIG. 3 is a block diagram showing an example of a configuration in a method according to an embodiment of the present disclosure.

FIG. 4 is a block diagram showing an example of a functional configuration in a method according to an embodiment of the present disclosure.

FIG. 5 is a flowchart showing an example of processing in a method according to an embodiment of the present disclosure.

FIG. 6 is a flowchart showing an example of processing in method according to another embodiment of the present disclosure.

FIG. 7 is a schematic diagram for explaining a method according to another embodiment of the present disclosure.

### DETAILED DESCRIPTION

Embodiments of the present disclosure is described with reference to the accompanying drawings.

### 1. Overview

A method according to the present embodiment is a method for sensing occlusion by image recognition processing to an image acquired by a camera mounted on a vehicle. A camera mounted on a vehicle is utilized for, for example, a driving support system of the vehicle. The driving support system includes a preventive safety system, a remote driving system, a remote support system, and an autonomous driving system. For example, as for the remote driving system, it is assumed that a remote operator determines a situation around a vehicle based on an image acquired by a camera mounted on the vehicle and remotely drive the vehicle. Hereinafter, unless it is particularly specified, a camera indicates a camera mounted on a vehicle, and an image indicates an image acquired by a camera mounted on a vehicle.

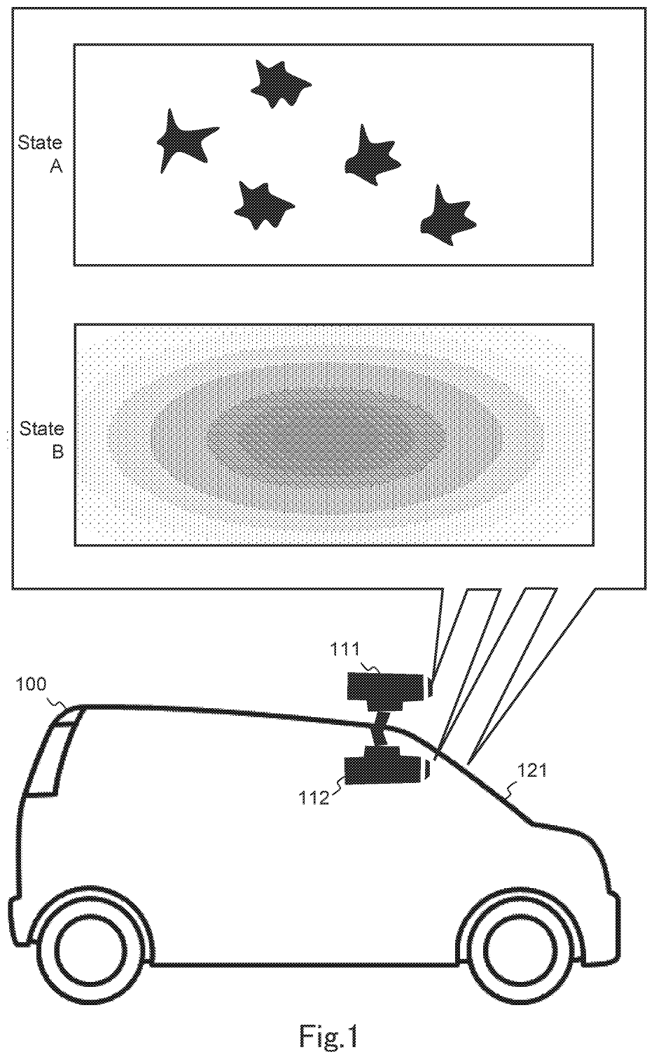

Poor visibility due to occlusion can occur to an image acquired by a camera. Occlusion means a state relating to a lens of a camera, a window glass of a vehicle, or the like that an object called a blindfold adheres to them and blocks light, or they are hazed or misted. Occlusion obscures view of a camera. For example, in FIG. 1, occlusion occurs to any one of a camera 111 mounted outside a vehicle 100, a camera 112 mounted inside the vehicle 100, and a windshield 121. Both state A and state B are occlusion. State A is a state that light is blocked due to adhesion of blindfolds, and state B is a state that hazing or misting occurs. Examples of a blindfold include a fallen leave, a petal, a plastic bag, a mud stain, a bird dropping, and dust. Examples of a substance causing hazing or misting include dew condensation, freezing, and fogging. As shown in FIG. 1, cameras include a camera mounted outside a vehicle and a camera mounted inside a vehicle. In a case where a camera is mounted inside a vehicle, poor visibility due to occlusion occurs not only when occlusion occurs to the lens of the camera, but also when occlusion occurs to a window glass in a direction that the camera faces. Hereinafter, unless it is particularly specified, occlusion indicates an entire state of occlusion that causes poor visibility to a camera. It is not distinguished whether occlusion occurs to a lens or a window glass. While the camera shown in FIG. 1 is used to recognize a front direction, a camera may be used to recognize other directions, for example, a side direction or a rear direction.

Since an image acquired by a camera has a large size of information about a situation around a vehicle, if a camera continues being used with poor visibility due to occlusion, there is a possibility that the vehicle is prevented from normally driving. Therefore, in a system using a camera, when poor visibility due to occlusion occurs and thereby occlusion is sensed, some measures to deal with the occlusion is taken in most cases. For example, in a case where occlusion is sensed in a remote support system of a vehicle, it is assumed to deactivate the camera and notify an operator that the camera cannot be utilized. Alternatively, for example, in a case where occlusion is sensed in an autonomous driving system of a vehicle, it is assumed to terminate the system and forcibly switch the driving mode of the vehicle to manual driving mode. In order to appropriately deal with the occlusion, it is important to accurately determine whether poor visibility due to occlusion occurs or not.

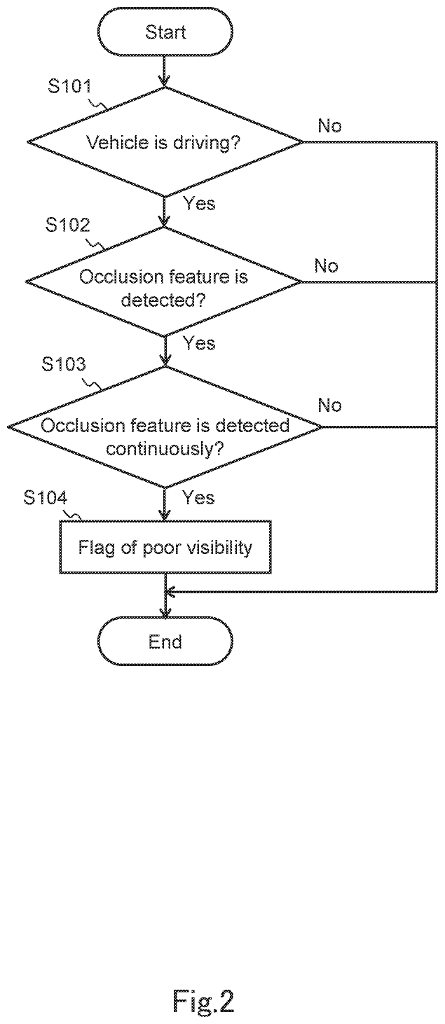

Here, a comparative technique for sensing occlusion compared to the present embodiment is described. FIG. 2 is a flowchart showing an example of processing according to the comparative technique. In Step S101, it is determined whether the vehicle is driving or not. When the vehicle is driving (Step S101; Yes), the processing proceeds to Step S102. When the vehicle is not driving (Step S101; No), the processing ends.

In Step S102, it is determined whether an occlusion feature is detected from the image. When an occlusion feature is detected (Step S102; Yes), the processing proceeds to Step S103. When an occlusion feature is not detected (Step S102; No), the processing ends. The occlusion feature is a feature indicating a possibility of occurrence of poor visibility due to occlusion relating to image recognition processing. The occlusion feature can be detected by extracting feature quantity from an image based on change of luminance of each pixel, brightness, color of an object, or the like. Typically, when feature quantity is not sufficiently obtained from an image, it is determined that an occlusion feature is detected.

In Step S103, it is determined whether the occlusion feature is detected continuously or not. When the occlusion feature is detected continuously (Step S103; Yes), the processing proceeds to Step S104. When the occlusion feature is no longer detected (Step S103; No), the processing ends.

In Step S104, a flag of poor visibility is set. Thereafter, the processing ends.

Steps S102 to S103 in the flowchart of FIG. 2 are processes for sensing occlusion. In the comparative example, occlusion is sensed in response to an occlusion feature being detected continuously from an image. When occlusion is sensed, a flag of poor visibility is set, and the flag is used when controlling the vehicle to deal with the occurrence of poor visibility due to occlusion. Since an image is used when a vehicle is driving in most cases, processing of sensing occlusion is typically executed when the vehicle is driving as shown in FIG. 2.

When occlusion is sensed, by setting a flag of poor visibility as shown in the comparative technique, it is possible to avoid subsequently using an image with poor visibility due to occlusion in, for example, a driving support system of a vehicle. However, when an image becomes dim due to blurring, an occlusion feature is detected from the image even when occlusion does not actually occur to the image. This occurs, for example, because the image becomes dim and feature quantity is not sufficiently obtained from the image. Therefore, in the comparative example, when an image is blurred, it is erroneously determined that poor visibility due to occlusion occurs although occlusion does not actually occur. The blur occurs to the image when the camera moves widely in a horizontal direction, a vertical direction, or an oblique direction during capturing of the image, that is, while a shutter of the camera is open. About a camera mounted on a vehicle, such movement of the camera is often caused by a motion of the vehicle.

Therefore, in the method according to the present embodiment, sensing occlusion is ceased while a motion of the vehicle that induces a blur of the image is sensed. The motion of the vehicle that induces a blur is a motion of the vehicle that moves in a horizontal direction, a vertical direction, or an oblique direction against the direction of the camera. Hereinafter, the motion of the vehicle that induces a blur is referred to as a blur-inducing motion. By ceasing sensing occlusion while the blur-inducing motion is sensed, it is possible to prevent erroneously determining that poor visibility due to occlusion occurs because of the blur in the image.

### 2. Example of Configuration

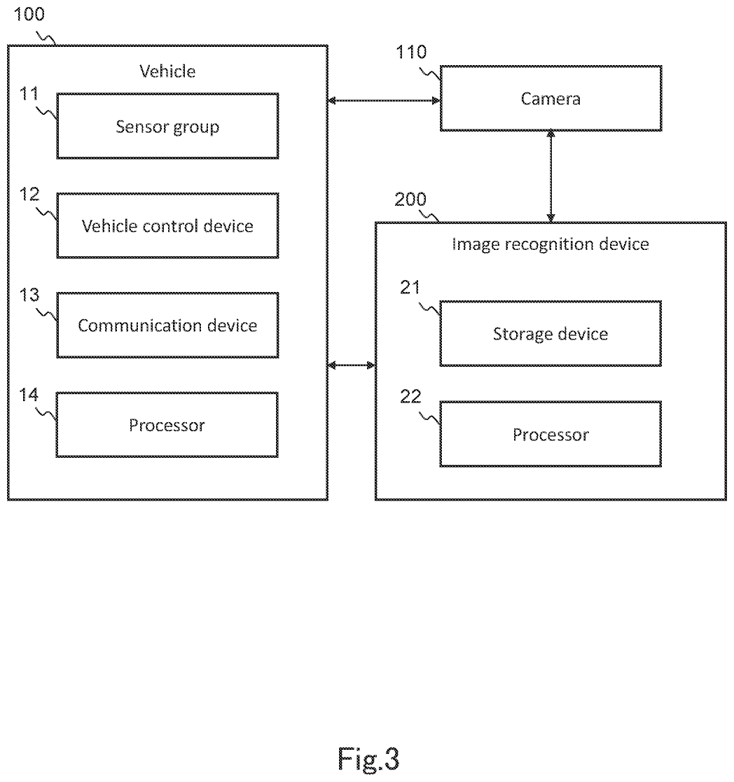

FIG. 3 shows an example of a configuration for realizing the method according to the present embodiment. The configuration shown in FIG. 3 includes a vehicle 100, a camera 110, and an image recognition device 200. The camera 110 is a camera mounted on the vehicle 100 and includes the camera 111 and the camera 112 shown in FIG. 1. The vehicle 100 includes a sensor group 11, a vehicle control device 12, a communication device 13, and at least one processor 14 (hereinafter simply referred to as the processor 14). The image recognition device 200 includes a storage device 21 and at least one processor 22 (hereinafter simply referred to as the processor 22). The vehicle 100, the camera 110, and the image recognition device 200 are configured to be able to communicate with each other. The image recognition device 200 may be included in the vehicle 100 or may be included in a server configured to be able to communicate with the vehicle 100, which is not illustrated.

The sensor group 11 is a group of sensors mounted on the vehicle 100, such as a yaw rate sensor, a pitch rate sensor, a roll sensor, and a steering angle sensor. The vehicle control device 12 controls the vehicle 100. The communication device 13 is configured to be able to communicate with the outside of the vehicle 100. The processor 14 may be a processor of an electronic control unit (ECU) or may be a processor mounted on the vehicle 100 that is differ from the ECU. The storage device 21 stores at least one program, and the processor 22 executes at least one program stored in the storage device 21.

### 3. Example of Functional Configuration

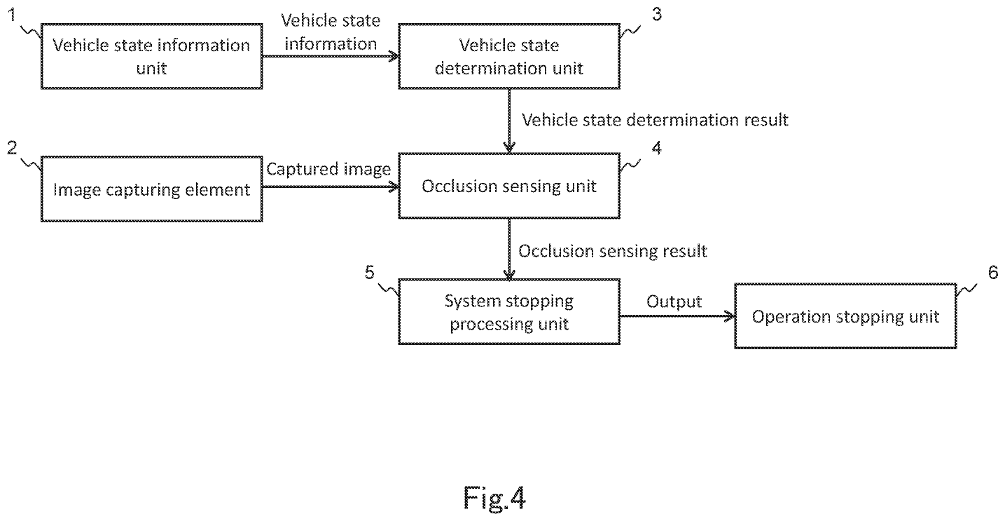

A block diagram of FIG. 4 shows an example of a functional configuration included in the configuration of FIG. 3. The method according to the present embodiment is executed by, for example, the functional configuration shown in FIG. 4.

A vehicle state information unit 1 acquires vehicle state information. The vehicle state information is information about the motion of the vehicle 100, such as a yaw rate, a pitch rate, or a steering angle. A vehicle state information unit 1 is included in, for example, each of the sensors constituting the sensor group 11. An image capturing element 2 captures an image. The image capturing element 2 is included in the camera 110.

In response to input of the vehicle state information from the vehicle state information unit 1, a vehicle state determination unit 3 determines whether the blur-inducing motion occurs or not. In response to input of vehicle state determination result output from the vehicle state determination unit 3 and input of a captured image output from the image capturing element 2, an occlusion sensing unit 4 senses occlusion. The occlusion sensing unit 4 ceases sensing occlusion while the blur-inducing motion is sensed. Occlusion sensing result that is output from the occlusion sensing unit 4 is input into a system stopping processing unit 5 and the system stopping processing unit 5 executes system stopping processing based on the occlusion sensing result. When occlusion is sensed, an instruction to stop operation of each system that is output from the system stopping processing unit 5 is input into an operation stopping unit 6 of each system and operation of each system is stopped. A system whose operation is stopped by the operation stopping unit 6 is, for example, a camera system in a remote support system of a vehicle or an autonomous driving system of a vehicle. When the operation stopping unit 6 stops a system, the vehicle control device 12 executes processing of suppressing a risk attendant on stopping a system. For example, when a camera system in a remote support system is stopped, the driver is informed of stopping support using the camera system. In addition, when an autonomous driving system is stopped, the vehicle is evacuated automatically to a safe place such as a edge of a road.

The vehicle state determination unit 3 may be included in the processor 14 or may be included in the processor 22. The occlusion sensing unit 4 and the system stopping processing unit 5 are included in the processor 22. The operation stopping unit 6 may be included in the vehicle control device 12 or may be included in a driving support system, which is not illustrated in FIG. 3.

### 4. Example of Processing

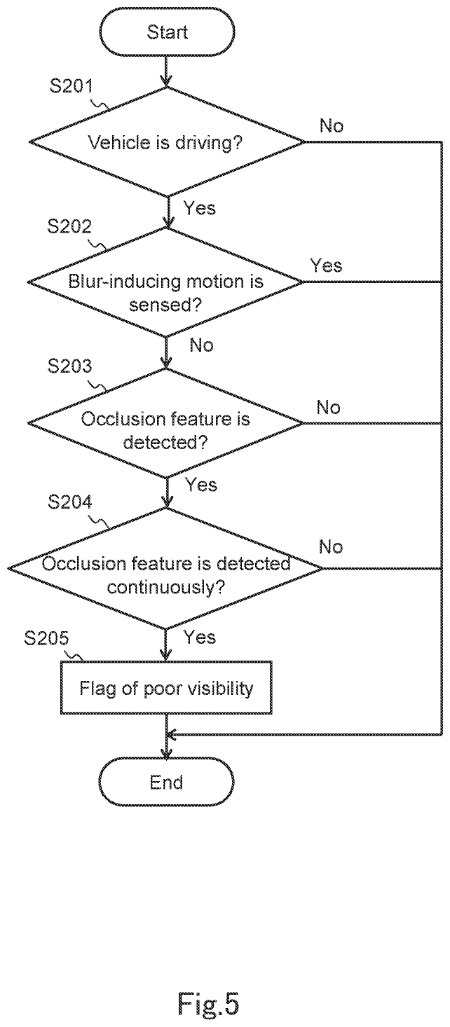

FIG. 5 is an example of a flowchart for executing the method according to the present embodiment. Processing of the flowchart shown in FIG. 5 is repeatedly executed at a predetermined cycle. In Step S201, similarly to the comparative technique, it is determined whether the vehicle is driving or not. When the vehicle is driving (Step S201; Yes), the processing proceeds to Step S202. When the vehicle is not driving (Step S201; No), the processing ends.

In Step S202, it is determined whether a blur-inducing motion is sensed. When a blur-inducing motion is not sensed (Step S202; No), the processing proceeds to Step S203. When the blur-inducing motion is sensed (Step S202; Yes), the processing ends.

In Step S203 to Step S205, the same processes as Step S102 to Step S104 in the comparative technique is executed. In Step S203 and Step S204, similarly to the comparative technique, it may be determined that an occlusion feature is detected when feature quantity is not sufficiently obtained from the image. In Step S205, a flag of poor visibility is set and then the processing ends.

The processing shown in FIG. 5 is executed by the occlusion sensing unit 4. As shown in the flowchart, in the method according to the present embodiment, a process of sensing occlusion is not executed while a blur-inducing motion is sensed. Therefore, it is possible to reduce erroneously determining that poor visibility due to occlusion occurs because of a blur in the image. Occlusion may be sensed in response to detection of an occlusion feature from the image regardless of duration of the detection. Alternatively, occlusion may be sensed in response to an occlusion feature being detected continuously from the image for a predetermined time or more as shown in Step S203 and Step S204 in FIG. 5.

### 5. Specific Example of Motion of Vehicle

Specific examples of a blur-inducing motion include turning and bouncing of the vehicle. Turning is a horizontal motion of the vehicle. Bouncing is a vertical motion of the vehicle and occurs, for example, when the vehicle drives on a rugged road. A camera to recognize forward is mostly used among cameras mounted on the vehicle. About a camera to recognize forward, turning or bouncing of the vehicle is most likely to cause blur in the image among various types of motion of the vehicle. Turning of the vehicle is likely to cause a blur in the image in horizontal direction and bouncing of the vehicle is likely to cause a blur in the image in vertical direction. Therefore, by making a blur-inducing motion be turning or bouncing of the vehicle and ceasing sensing occlusion while at least one of turning and bouncing of the vehicle is being sensed, it is possible to more correctly prevent erroneous determination.

Example of processing when the blur-inducing motion is made to be turning or bouncing is given below. In the example, Step S202 in FIG. 5 is made to be a process of sensing turning or bouncing. When neither turning nor bouncing is sensed (Step S202; No), the processing proceeds to Step S203. When at least one of turning and bouncing is sensed (Step S202; Yes), the processing ends.

Sensing turning and bouncing of the vehicle is enabled by referring to, for example, the vehicle state information, map information, or GPS information. The vehicle state information is acquired by a sensor included in the sensor croup 11, that is, for example, a yaw rate sensor, a pitch rate sensor, or a steering angle sensor. The map information and the GPS information are acquired by the communication device 13. As a method of sensing turning of the vehicle, a method of determining that the vehicle is turning when the yaw rate acquired by the yaw rate sensor is equal to or greater than a predetermined value, a method of determining that the vehicle is turning when the steering angle is equal to or greater than a predetermined value, or a method of determining that the vehicle is turning when the vehicle is driving at an intersection or a curving place based on the map information and the GPS information is assumed, for example. Further, as a method of sensing bouncing, a method of determining that the vehicle is bouncing when the pitch rate acquired by the pitch rate sensor is equal to or greater than a predetermined value, or a method of determining bouncing based on a state of vibration of a suspension or a state of a load is assumed, for example. If the map information includes information about rugged level of a road corresponding to a state of a paved surface of a road, it is possible to estimate whether bouncing occurs or not from the information about it. A motion of the vehicle that is sensed as turning may include only a motion that the yaw angle of the vehicle changes in one direction or may include a motion that the vehicle continuously moves from side to side driving in a serpentine course.

### 6. Another Embodiment

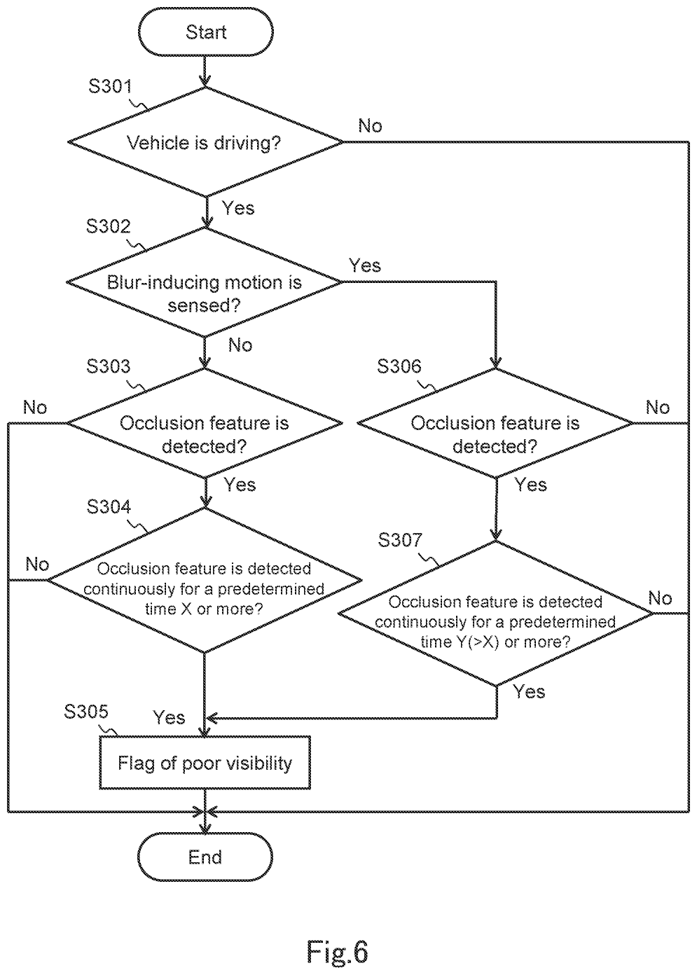

As a method for reducing erroneously determining that poor visibility due to occlusion occurs, another embodiment of is given according to the present disclosure. In this embodiment, occlusion is sensed in response to an occlusion feature being detected continuously from the image for a predetermined time or more. While the blur-inducing motion is sensed, the predetermined time is set longer than while the blur-inducing motion is not sensed. FIG. 6 shows an example of a flowchart in this embodiment. The processing of the flowchart shown in FIG. 6 is repeatedly executed at a predetermined cycle.

Step S301 is the same as Step S201 in the flowchart of FIG. 5. In Step S302, similarly to the flowchart in FIG. 5, it is determined whether a blur-inducing motion is sensed or not. When a blur-inducing motion is not sensed (Step S302; No), the processing proceeds to Step S303. When a blur-inducing motion is sensed (Step S302; Yes), the processing proceeds to Step S306.

In Step S303, it is determined whether an occlusion feature is detected from the image or not. When an occlusion feature is detected (Step S303; Yes), the processing proceeds to Step S304. When an occlusion feature is not detected (Step S303; No), the processing ends.

In Step S304, it is determined whether the occlusion feature is detected continuously for a predetermined time X or more. When the occlusion feature is detected continuously for the predetermined time X or more (Step S304; Yes), the processing proceeds to Step S305. When the time for which the occlusion feature is detected is shorter than the predetermined time X (Step S304; No), the processing ends.

In Step S306, it is determined whether an occlusion feature is detected from the image or not. When an occlusion feature is detected (Step S306; Yes), the processing proceeds to Step S307. When an occlusion feature is not detected (Step S306; No), the processing ends.

In Step S307, it is determined whether the occlusion feature is detected continuously for a predetermined time Y or more. When the occlusion feature is detected continuously for the predetermined time Y or more (Step S307; Yes), the processing proceeds to Step S305. When the time for which the occlusion feature is detected is shorter than the predetermined time Y (Step S307; No), the processing ends.

In Step S305, a flag of poor visibility is set. Thereafter, the processing ends.

In the flowchart shown in FIG. 6, it is determined whether an occlusion feature is continuously detected from the image for a predetermined time or more in both cases where a blur-inducing motion is sensed and a blur-inducing motion is not sensed. However, the predetermined time Y, which is set when a blur-inducing motion is sensed, is longer than the predetermined time X, which is set when a blur-inducing motion is not sensed.

An occlusion features is sometimes detected from an image only for a short time. An occlusion features that is detected only for a short time is caused by, for example, malfunction of a camera, halation due to penetration of light, temporally adhesion of water droplets to the window during the time between start of rain and activating a wiper. In such a case, that is, a case where an occlusion feature is detected only for a short time, it is not required that a camera system deal with the occlusion. Therefore, the predetermined time X is provided in order to prevent occlusion from being sensed in such a case. X may be set, for example, 12 seconds if such occlusion feature that is detected only for a short time finishes being detected about 10 seconds later in many cases. Herewith, it is possible to prevent occlusion from being sensed because of an occlusion feature that is detected only for a short time.

However, in a case where a blur-inducing motion occurs after such occlusion feature that is detected only for a short time occurs and until the occlusion feature finishes being detected, there is a possibility that the occlusion feature is continuously detected for the predetermined time X or more and it is erroneously determined that poor visibility due to occlusion occurs.

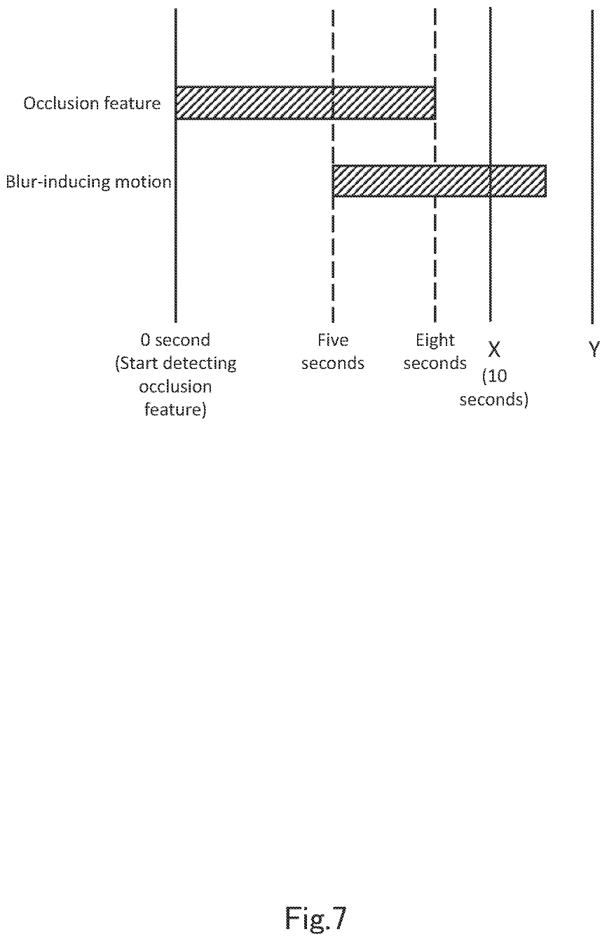

For example, in an example shown in FIG. 7, the predetermined time X is set 10 seconds. Since an occlusion feature that is detected only for a short time finishes 8 seconds later (before 10 seconds have passed) according to the example shown in FIG. 7, occlusion is not sensed if a blur-inducing motion does not occur. However, because of a blur-inducing motion that starts 5 seconds later, an occlusion feature is detected continuously for more than 10 seconds. It means that there is a possibility that occlusion is sensed in a method other than the method of the present disclosure. In order to prevent this, the predetermined time is set the predetermined time Y, which is longer than the predetermined time X, while the blur-inducing motion is sensed. Herewith, it is possible to reduce erroneously determining that poor visibility due to occlusion occurs.

The predetermined time Y may be, for example, a time obtained by adding the predetermined time X and a time where a blur-inducing motion is sensed or may be set a constant time longer than the predetermined time X. For example, the predetermined time Y may be set 13 seconds when the predetermined time X is 10 seconds and a blur-inducing motion is sensed for 3 seconds, or the predetermined time Y may be set 15 seconds regardless of a time where a blur-inducing motion is sensed.

### 7. Example of Modified Embodiment

As an example of a modified embodiment of the method, sensing occlusion may be ceased only at night or when the exposure time of the camera is set longer than a threshold value. At night or when the exposure time of the camera is set longer than a threshold value, blur in the image is likely to become larger than usual. By ceasing sensing occlusion only in such a scene, in which a blur in the image is likely to occur, it is possible to determine whether poor visibility due to occlusion occurs more accurately.

As described above, in the method according to the present embodiment, sensing occlusion is ceased while a motion of the vehicle that induces a blur in the image is sensed. Herewith, it is possible to reduce erroneously determining that poor visibility due to occlusion occurs.

What is claimed is:

1. A method comprising:
sensing occlusion by image recognition processing to an image acquired by a camera mounted on a vehicle;
sensing a blur-inducing motion, the blur-inducing motion being a motion of the vehicle inducing a blur in the image; and
ceasing sensing the occlusion while the blur-inducing motion is sensed.

2. A method comprising:
detecting an occlusion feature from an image acquired by a camera mounted on a vehicle;
sensing occlusion in response to the occlusion feature being detected continuously for a predetermined time or more
sensing a blur-inducing motion, the blur-inducing motion being a motion of the vehicle inducing a blur in the image; and
setting the predetermined time longer while the blur-inducing motion is sensed than while the blur-inducing motion is not sensed.

3. The method according to claim 1, wherein the blur-inducing motion includes turning or bouncing of the vehicle.

4. The method according to claim 2, wherein the blur-inducing motion includes turning or bouncing of the vehicle.

5. A system comprising at least one processor capable of executing at least one program,
wherein the at least one processor is configured to, upon execution of the at least one program, execute:
sensing occlusion state by image recognition processing to an image acquired by a camera mounted on a vehicle;
sensing a blur-inducing motion, the blur-inducing motion being a motion of the vehicle inducing a blur in the image; and
ceasing sensing the occlusion while the blur-inducing motion is sensed.

6. The system according to claim 5, wherein the blur-inducing motion includes turning or bouncing of the vehicle.
